(19) United States
(12) Patent Application Publication
(10) Pub. No.: US 2006/0273074 A1
(43) Pub. Date: Dec. 7, 2006

(54) LASER MACHINING METHOD AND LASER MACHINING MACHINE

(75) Inventor: Yoji Asahi, Nagano-shi, Nagano (JP)

Correspondence Address: RANKIN, HILL, PORTER & CLARK LLP, 4080 ERIE STREET, WILLOUGHBY, OH, 44094-7836, US

(73) Assignee: SHINKO ELECTRIC INDUSTRIES CO., LTD., Nagano-shi (JP)

(21) Appl. No.: 11/421,596

(22) Filed: Jun. 1, 2006

(30) Foreign Application Priority Data
Jun. 2, 2005 (JP) 2005-163170

(51) Int. Cl. B23K 26/38

(52) U.S. Cl. 219/121.71; 219/121.7

(57) ABSTRACT

The position data column to move the laser beam is formed by assigning each position coordinate to the holes H11 and H12 in a T1 code one by one, assigning each position coordinate the holes H21 and H22 in a T2 code two by two, and assigning the position coordinate to the hole H31 in a T3 code three by three. The laser beam is moved on the substrate sequentially from the end as indicated by arrows of movement 1 to movement 5. Then, H11 is irradiated with 1 shot of the laser beam that is converged into a minimum diameter among plural types of hole diameters, H21 is irradiated with 2 shots, H31 is irradiated with 3 shots, H12 is irradiated with 1 shot of the laser beam, and H22 is irradiated with 2 shots. When the laser beam is irradiated one shot by one shot by the number of position data in response to a size of the hole diameter, the holes having different hole diameters can be formed.

### TECHNICAL FIELD

The present disclosure relates to a laser machining method and a laser machining machine. More particularly, the present disclosure relates to a laser machining method and a laser machining machine of forming effectively a plurality of holes with different diameters in a work piece such as a multi-layered wiring substrate, or the like by using a laser beam focused into a predetermined spot.

### RELATED ART

Recently, the higher density and the narrower lead pitch of the packaging parts mounted on the printed-wiring board are made progress on account of the improvement in function of the electronic device. In order to respond to such progress, a diameter of the via hole formed in the printed-wiring board is also miniaturized. Also, the multi-layered wiring substrate to improve a packaging density of the circuit is frequently used.

In the related art, the step of forming the hole in the printed-wiring board is performed by the machining using the numerical control (NC) drill or the processing using the exposure technology (photo via system). However, the NC drill has such problems that there is a limit to a diameter of the bored hole, an edge of the drill is broken, and others. Also, the photo via system has such problems that there is a limit to a diameter of the bored hole and the cost of materials is brought up.

Therefore, as the means for solving such problems, the laser machining machine capable of forming fine holes by a laser beam is used recently. In the laser machining machine, as shown in FIG. 14, a pulse laser beam L is generated from a laser beam outputting device 1 including a laser oscillator, and then this laser beam L is focused on a substrate 5 as a work piece loaded on a machining table 3 by a focusing optical system 2.

In this laser machining machine, the number of pulses and an energy applied to one hole are adjusted by a processing portion 41 in a control unit 4 in compliance with control data stored in a storing portion 42 to realize the hole in desired depth. Also, NC position control of the machining table 3 is executed in compliance with the control data stored in the storing portion 42. Thus, a converging point of the laser beam L is adjusted onto a plurality of machining positions, in which the formation of the hole is scheduled, on the substrate 5 by this control.

Meanwhile, the approach to reduce a diameter of the hole by placing a mask, which is used to define a diameter, on a laser beam guiding path and then narrowing down the laser beam by this mask has been proposed variously (see Japanese Patent Unexamined Publication No. Hei. 9-271972, Japanese Patent Unexamined Publication No. Hei. 9-293946, and Japanese Patent Unexamined Publication No. 2000-263263 which are referred as Patent Literatures 1 to 3 respectively, for example). The mask set forth in Patent Literature 1 is constructed by a rotating plate that can change the diameter of the via hole provided in the printed-wiring board as the work piece at a high speed. A wide variety of holes which are used to define a plurality of via hole and through which the laser beam is passed are provided in this rotating plate. This rotating plate is arranged in the course of the optical path of the laser beam that is irradiated onto the substrate.

Also, the laser machining machine that changes the diameter of the hole bored in the work piece by devising a configurative of a laser beam focusing optical system has been proposed variously (see Patent Literature 2, and the like, for example). The laser machining machine set forth in Patent Literature 2 includes an image transferring optical system having a lens that forms an image of the mask, which is inserted in the optical path between the laser oscillator and the work piece, on a machining surface in reduced size, the focusing optical system, and a selecting means for selecting either of the image transferring optical system and the focusing optical system. The NC control unit controls the image transferring optical system, the focusing optical system, and the selecting means and selects either of the image transferring optical system and the focusing optical system in response to a diameter of the bored hole and a depth of the hole.

In the above laser machining machines, the hole formation is executed by using the laser beam that is converted to meet to the diameter of the hole opened in the work piece, and the masks having plural types of holes and the focusing optical system whose converged diameter can be changed are employed to change a size of the hole diameter. In contrast, the laser machining machine that can change a size of the hole diameter by irradiating the laser beam, which is converged into a predetermined spot, plural times while shifting its position has been proposed (see Patent Literature 3, and Japanese Patent Unexamined Publication No. 2004-87879 which is referred as Patent Literature 5, and the like, for example).

Meanwhile, the laser machining machine that forms through holes, which are aligned almost like a lattice at a narrow pitch interval, on a silicon chip as the work piece in response to an increase of I/O pads on the chip by irradiating the laser beam has been proposed (see Japanese Patent Unexamined Publication No. 2002-35977 which is referred as Patent Literature 4, for example). In this laser machining machine, the hole forming method of forming a high-precision through hole by preventing deformation and deterioration of a sheet member and deformation of the through hole because of inferior heat radiation of the machining heat when the laser beam is irradiated is employed.

According to this hole forming method, the through holes aligned in an almost lattice fashion are formed in a predetermined sheet as the work piece by irradiating the laser beam. A hole forming point positioned in the almost center portion of the lattice alignment is set as a starting point. The laser beam converged into a predetermined spot is irradiated while moving the hole forming point like an almost concentric circle from this starting point toward the outside. In particular, the step of irradiating at least one pulse of the laser beam to all the hole forming points that are aligned in an almost lattice fashion is repeated plural times, and thus the through hole is formed at all hole forming points.

By the way, a large number of vias are needed in the built-up multi-layered wiring substrate. In such vias, it is important to ensure reliability of the via connection and also it is important to reduce a wiring resistance in the vias in the power supply system. Therefore, as the demand for package design from the designer side of the wiring substrate, the hole diameter of the via should be changed on the same laminated layer in answer to the use of the via.

As the via whose hole diameter is changed in answer to the use of the via, for example, in the case of the wiring via in the power supply system, a resistance value is lowered by enlarging the hole diameter. Also, in the case of the stacked via that is subjected to a stress as a thermal stress, the via that is formed on the through hole plating (PTH), and the like, a connection strength is increased by enlarging the hole diameter. Alternately, in the case of the via that is not subjected to a stress as a thermal stress, a density of the via numbers is increased by reducing the hole diameter. In this manner, improvements in the package characteristic and the reliability can be achieved.

In the case where a large number of vias required for the multi-layered wiring substrate are formed by the laser beam punching while using the above laser machining machine in the related art, when a plurality of vias with different hole diameters are formed in the same layer, first the formation of all vias having the hole diameter in size of one type is executed on the whole surface of the substrate in first step, then the converging spot size of the laser beam is changed into the hole diameter in different size, and then the formation of all vias having such hole diameter in different size is executed again on the whole surface of the substrate. In this fashion, the steps of forming plural types of vias having different hole diameters are repeated on the overall surface of the substrate while changing the converging spot size of the laser beam.

In the case where the steps of forming a plurality of vias having different hole diameters are executed according to the hole forming procedures described above, when the laser machining machine shown in FIG. 14 in the related art is employed, the mechanical motion of the machining table 3 executed under the machining position control is repeated over the whole surface of the substrate 5 plural times equal to the number of different hole diameters. For this reason, a useless time is generated during the hole forming time required for a sheet of substrate, and thus the cost is increased about 1.3 to 1.5 times rather than the case where the vias all having the same hole diameter are formed on the same surface. As a result, employment of the multi-layered wiring substrate that needs a change of hole diameter in the same layer is restricted in design.

### SUMMARY

The disclosure below describes a laser machining method and a laser machining machine, capable of forming effectively a large number of plural types of required vias in a printed-wiring board or in the same layer in a built-up multi-layered wiring substrate and also improving a degree of freedom in package design.

An example implementation of the invention is described below. A laser machining method of opening a plurality of holes having different hole diameters in a work piece by irradiating a laser beam converged into a predetermined diameter, includes a moving step of relatively moving an irradiating unit of the laser beam, the predetermined diameter of which is converged to agree with a minimum diameter among the plurality of holes, to a machining position of the hole sequentially; and an irradiating step of irradiating the laser beam predetermined times in response to a size of the hole diameter at the machining position when the irradiating unit is relatively moved to the machining position respectively.

Also, after the irradiating unit is relatively moved to the machining position, the laser beam is irradiated once to the work piece when the hole diameter in the machining position is the minimum diameter, and the laser beam is irradiated twice or more to the work piece in response to a size of the hole diameter when the hole diameter in the machining position is larger than the minimum diameter. Further, the irradiating unit is moved via a route selected such that a moving distance between machining positions of the plurality of holes is shortest.

Also, the present invention provides the laser machining method, which further includes an inputting step of inputting machining position data and hole diameter information of the plurality of holes; a grouping step of grouping the machining position data in response to sizes of the hole diameters contained in the hole diameter information about the plurality of holes; and a condition imposing step of imposing a condition to irradiate the laser beam once to the machining position data belonging to a group in which the hole diameter is a smallest diameter, and imposing a condition to irradiate the laser beam twice or more sequentially in response to a size of the hole diameter to the machining position data belonging to respective groups in which the hole diameters are classified in order of larger diameter than the minimum diameter; wherein the laser beam is irradiated predetermined times in compliance with the condition imposed to the machining position data when the irradiating unit is moved to respective machining positions.

Also, the machining position data has position coordinates on the work piece, the machining position data are converted by a data converting step of setting one position coordinate on the machining position under a condition the laser beam is irradiated once, and setting two position coordinates or more on the machining position under a condition the laser beam is irradiated twice or more in response to the size of the hole diameter, and the laser beam is irradiated predetermined times equal to the number of position coordinates in compliance with the number of position coordinates contained in the machining position data when the irradiating unit is moved to respective machining positions.

Also, when the hole in the machining position is a power supply wiring via, a stacked via to which a stress like a thermal stress is applied, or a via that undergoes a through hole plating after the irradiating unit is moved to the machining position, the laser beam is irradiated twice or more in response to a size of the hole diameter.

The disclosure also describes a laser machining machine includes an irradiating unit for converging a laser beam into a predetermined diameter to agree with a minimum diameter among a plurality of holes that are opened in a work piece and have different hole diameters, and irradiating the laser beam onto the work piece from an irradiating portion; a moving unit for relatively moving machining positions of the plurality of holes in the work piece sequentially to a converged position of the laser beam; and a controlling unit for controlling a laser beam irradiation by the irradiating unit and alignment of the machining position with the converged position; wherein the control unit causes the irradiating unit to irradiate the laser beam predetermined times in response to a size of the hole diameter in the machining position when the irradiating unit is relatively moved to the machining positions of the plurality of holes sequentially.

Also, after the irradiating unit is relatively moved to the machining position, the control unit causes the irradiating unit to irradiate the laser beam once to the work piece when the hole diameter in the machining position is the minimum diameter, and causes the irradiating unit to irradiate the laser beam twice or more to the work piece in response to a size of the hole diameter when the hole diameter in the machining position is larger than the minimum diameter. Further, the irradiating unit is moved via a route selected such that a moving distance between machining positions of the plurality of holes is shortest.

Also, the present invention provides the laser machining machine, which further includes an inputting unit for inputting machining position data and hole diameter information of the plurality of holes; and a storing unit for storing the input machining position data and the input hole diameter information of the plurality of holes; wherein the control unit includes a grouping section for reading the machining position data and the hole diameter information from the storing unit, and then grouping the machining position data in response to sizes of the hole diameters contained in the hole diameter information about the plurality of holes, a condition imposing section for imposing a condition to irradiate the laser beam once to the machining position data belonging to a group in which the hole diameter is a smallest diameter, and imposing a condition to irradiate the laser beam twice or more sequentially in response to a size of the hole diameter to the machining position data belonging to respective groups in which the hole diameters are classified in order of larger diameter than the minimum diameter, and the control unit causes the irradiating unit to irradiate the laser beam predetermined times in compliance with the condition imposed to the machining position data when the irradiating unit is moved to respective machining positions.

Also, the machining position data input into the inputting unit has position coordinates on the work piece, the control unit has a data converting section for setting one position coordinate on the machining position in respective machining position data under a condition the laser beam is irradiated once, and setting two position coordinates or more on the machining position in respective machining position data under a condition the laser beam is irradiated twice or more in response to the size of the hole diameter, and the control unit causes the irradiating unit to irradiate the laser beam predetermined times equal to the number of position coordinates in compliance with the number of position coordinates converted by the data converting section when the irradiating unit is moved to respective machining positions.

Also, the data converting section forms coordinate data columns that contain X-axis coordinate data and Y-axis coordinate data of plural pieces of machining position data, and formed the coordinate data column to contain only one piece of the X-axis coordinate data and Y-axis coordinate data when the X-axis coordinate data and Y-axis coordinate data of the machining position data is same in groups on which a condition that the laser is irradiated twice or more in response to a size of the hole diameter is imposed.

In the laser machining machine, when the hole in the machining position is a power supply wiring via, a stacked via to which a stress like a thermal stress is applied, or a via that undergoes a through hole plating after the irradiating unit is moved to the machining position, the laser beam is irradiated twice or more in response to a size of the hole diameter.

Various implementations may include one or more the following advantages. Fr example, as described above, according to the present disclosure, in the laser machining that is applied to open a plurality of holes having different hole diameters in the work piece by irradiating the laser beam that is converged into a predetermined diameter, the predetermined diameter of the laser beam irradiated onto the work piece is set to a minimum diameter among plural types of hole diameters, the laser beams is moved sequentially to the machining positions of the holes, and the laser beams is irradiated predetermined times in answer to a size of the hole diameter in the concerned machining position when the laser beam is moved to respective machining positions. Therefore, even though a plurality of holes having different hole diameters are mixed together on the surface of the work piece, a change of the hole diameter of the hole can be executed smoothly and also the holes having plural types of hole diameters, which are present alternately, can be opened in a series of moving operations of the laser beam,

Further, according to the present disclosure, the irradiating unit is moved via a route selected such that a moving distance between machining positions of the plurality of holes is shortest. Therefore, when the holes having plural type of hole diameters are opened plural times, a moving operation time required to go back to the mechanical origin every time the formation of the hole of one type is ended can be eliminated, and a hole machining time can be shortened. Thus, a hole forming efficiency can be improved and also a cost reduction can be achieved,

Further, in the related art, when the layout that arranges a plurality of holes having different hole diameters on the same surface of the work piece is designed, the cost is increased. Therefore, for example, the package design of the multi-layered wiring substrate is influenced. However, when the hole machining method of the present invention by using the laser beam is employed, the design to open a plurality of holes having plural type of hole diameters can be employed easily, and also a margin of design can be improved.

### BRIEF DESCRIPTION OF THE DRAWINGS

FIG. 1 is a view explaining a configurative example of a laser machining machine to execute the laser machining method of a first embodiment of the present invention.

FIG. 2 is a graph explaining a relationship between the number of laser shots and the hole diameter in forming the hole by the laser beam.

FIGS. 3(a), (b) are views explaining schematically procedures of moving the position of the hole when the holes having different diameters are formed by the laser beam.

FIG. 4 is a view explaining procedures of moving the position of the hole when a plurality of holes having three types of diameters are formed in the substrate.

FIG. 5 is a view explaining details of machining procedures when a plurality of holes having three types of diameters are formed in the substrate.

FIG. 6 is a view explaining the position coordinates grouped in response to diameter codes and the position data columns when a plurality of holes having three types of diameters are formed in the substrate.

FIG. 7 is a flowchart explaining the machining procedures when a plurality of holes having three types of diameters are formed in the substrate.

FIG. 8 is a schematic view explaining an idea of punching process by a laser machining method of the present invention.

FIG. 9 is a view explaining how the laser machining method of the present invention is applied to a substrate to form a plurality of holes having different diameters.

FIG. 10 is a view explaining a configurative example of a laser machining machine to execute the laser machining method of a second embodiment of the present invention.

FIG. 11 is a view explaining position coordinates grouped in response to diameter codes and position data columns when a plurality of holes having three types of diameters are formed in the substrate by the laser machining method of the present invention.

FIG. 12 is a flowchart explaining procedures of setting position coordinates and machining conditions for punching in the laser machining method of the present invention.

FIG. 13 is a flowchart explaining procedures of forming a plurality of holes having different diameters in the substrate when the laser machining method of the present invention is applied.

FFIG. 14 is a view explaining a configurative example of a laser machining machine form the holes in the substrate by using a laser beam.

### DETAILED DESCRIPTION

Next, explanation of embodiments of the present invention concerning a laser machining method and a laser machining machine, which opens a plurality of holes having different diameters in a work piece by irradiating the laser beam that is converged into a predetermined spot, will be made hereinafter.

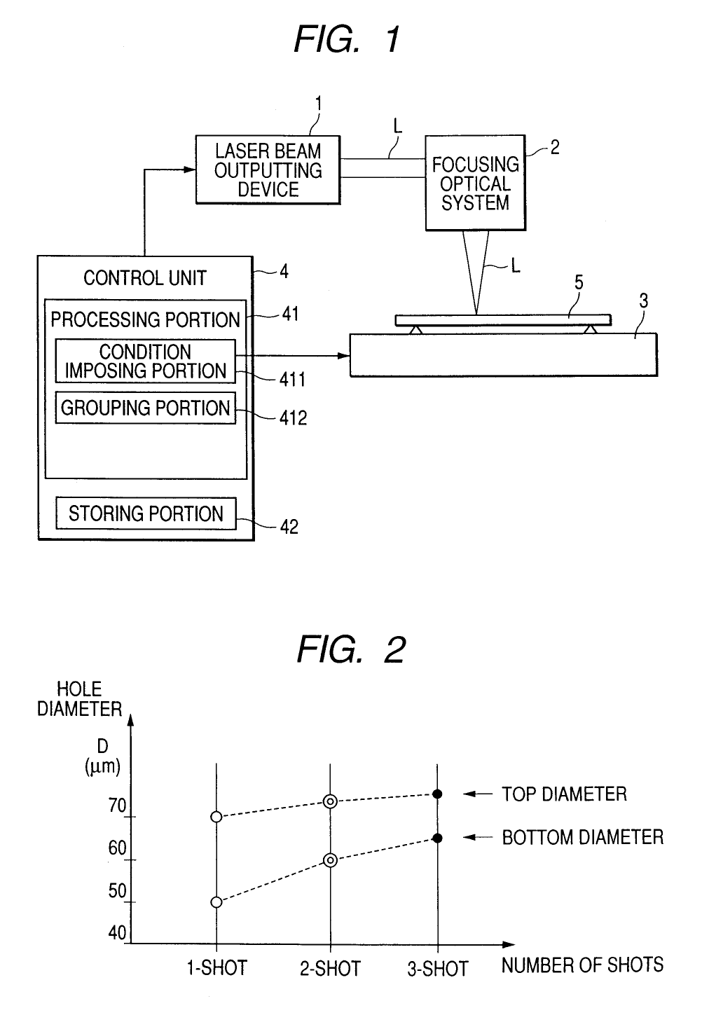

Firstly, a laser machining method and a laser machining machine according to the first embodiment of the present invention will be explained with reference to FIG. 1 to FIG. 7 hereinafter.

In the foregoing laser machining machine in the related art, when the diameter of the hole to be formed in the work piece is changed, the hole diameter is changed by either placing a mask having holes with different diameters on an optical path of the laser beam or exchanging a diaphragm of a laser beam focusing optical system. A dedicated mechanism is needed to change these hole diameters and thus the control becomes complicated. In addition, such problems existed that not only a cost increase is caused but also a hole machining time is protracted.

Therefore, the present invention uses a phenomenon that in the case where fine holes are opened by the laser beam, when the laser beam converged into a predetermined spot is irradiated onto the same position of the work piece plural times (plural shots), the hole having a diameter larger than the predetermined spot is opened. In the present invention, with use of this phenomenon, the holes having the different hole diameters can be formed by changing the number of shots of the laser beam of a predetermined diameter applied to the same position. Experimental examples of the hole formation are given in FIG. 2.

In FIG. 2, the abscissa denotes the number of shots and the ordinate denotes a size of hole diameter. Here, the case where the laser beam is converged to 50 μm as a predetermined diameter is shown. A white dot shows the case of 1-shot irradiation, a double circle shows the case of 2-shot irradiation, and a black dot shows the case of 3-shot irradiation. In the example in FIG. 2, the case where the through hole is opened in the work piece is shown, and it is seen that, although there is a difference between a top diameter and a bottom diameter of the through hole, the hole diameter is enlarged in response to the number of shots. According to this fact, when the number of irradiation times of the laser beam onto the hole machining position on the work piece is changed, the hole having a size larger than a predetermined diameter can be opened even by using the laser beam that is converged into the predetermined diameter.

A schematic configuration of the laser machining machine to which the laser machining method of the first embodiment is applied is shown in FIG. 1. The laser machining machine shown in FIG. 1 employs the laser machining machine shown in FIG. 14 as the basis, and the same reference symbols are affixed to the same portions. A difference of the laser machining machine shown in FIG. 1 from the laser machining machine shown in FIG. 14 is that a condition imposing portion 411, and a grouping portion 412 are provided to the processing portion 41.

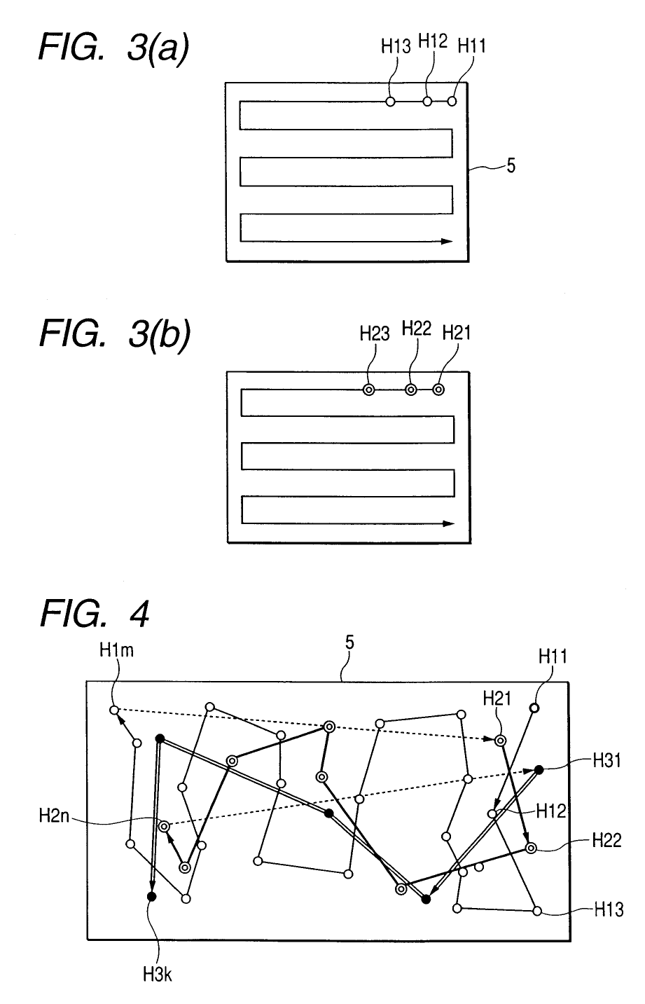

The case where a plurality of holes having different hole diameters are opened in a wiring substrate as an example of the work piece by utilizing the above principal of hole formation by the laser beam and the laser machining machine as shown in FIG. 1 will be explained with reference to FIGS. 3(a) and (b) hereunder. In the laser machining machine shown in FIG. 1, the substrate 5 is loaded on the machining table 3. The laser beam L is converged into a predetermined diameter by the focusing optical system 2. Then, when the control unit 4 executes the position control of the machining table 3 in compliance with position data stored in the storing portion 42, the focused lease beam is moved to the machining position.

In FIG. 3(a), the way of moving the laser beam in forming the holes H11, H12, H13, . . . each having a predetermined diameter sequentially is shown. The laser beam of predetermined diameter is 1-shot irradiated to machining positions of the holes H11, H12, H13, . . . represented by the white dot. In FIG. 3(b), the case where the hole whose diameter is larger than the predetermined diameter is sequentially opened is shown. The laser beam of predetermined diameter is 2-shot irradiated to machining positions of the holes H21, H22, H23, . . . represented by the double circle.

In FIGS. 3(b) and (b), procedures of moving the laser beam when the holes having different hole diameters are formed are shown respectively. Then, procedures of moving the laser beam, i.e., procedures of executing the position control of the machining table 3 when actually a plurality of holes having different hole diameters must be opened in the wiring substrate will be explained with reference to FIG. 4 hereunder. In FIG. 4, an example of the case where a plurality of holes having three types of hole diameters are opened in the substrate 5 is illustrated. In FIG. 4, the white dot indicates the machining position of the hole having a smallest diameter, the double circle indicates the machining position of the hole having a diameter larger than the smallest diameter by one stage, and the black dot indicates the machining position of the hole having a diameter further larger by one stage.

When a plurality of holes having the diameters of three types are to be opened in the substrate 5, the machining positions of the holes having the diameter of the same type are classified into groups. In FIG. 4, the machining positions are classified into three groups indicated by the white dot, the double circle, and the black dot. The laser beam is 1-shot irradiated to the machining positions belonging to the first group, the laser beam is 2-shot irradiated to the machining positions belonging to the second group, and the laser beam is 3-shot irradiated to the machining positions belonging to the third group. Suppose that the machining positions belonging to these groups are spread to the overall surface of the substrate 5.

Therefore, the laser beam converged into a predetermined diameter is irradiated to the hole machining positions in respective groups with one shot to three shots selectively while shifting the machining position sequentially. In such case, the route to reduce a moving length of the laser beam to the lowest minimum is selected from respective groups, and the moving orders of the machining position are set. As shown in FIG. 4, the machining position (white dot) in which the holes H11, H12, H13, . . . H1m having a predetermined diameter respectively is moved from H11 as a starting point to H1m indicated on the upper left-hand portion of the substrate 5, as indicated by a solid line. The control unit 4 executes the control in such a manner that the laser beam outputting device 1 1-shot irradiates the laser beam every time when the laser beam irradiation position is moved from the machining position H11 to H1m.

Then, in order to open the holes H21, H22, H23, . . . H2n displayed by the double circle in the second group, the control unit 4 controls the laser beam outputting device 1 to 2-shot irradiate the laser beam every machining position. Then, the control unit 4 causes the machining table 3 to move from the laser beam irradiation position H1m to H21, as indicated by a broken line in FIG. 4, and then causes the machining table 3 to move from H21 as the starting point to H22, H23, . . . H2n in sequence, as indicated by a thick solid line in FIG. 4. The control unit 4 executes the control such that the laser beam outputting device 1 2-shot irradiates the laser beam every time when the laser beam irradiation position is moved to the machining position until the irradiation position comes up to H2n shown on the substrate 5.

Then, like the case of the first and second groups, in order to open the holes H31, H32, H33, . . . H3k displayed by the black dot in the third group, the control unit 4 controls the laser beam outputting device 1 to 3-shot irradiate the laser beam every machining position. Then, the control unit 4 causes the machining table 3 to move from the laser beam irradiation position H2n to H31, as indicated by a broken line in FIG. 4, and then cause the laser beam outputting device 1 to 3-shot irradiate the laser beam until H3k every time when the laser beam irradiation position is moved to the machining position while moving the laser beam irradiation position from H31 as a starting point to H32, H33, . . . H3k in sequence, as indicated by a double line in FIG. 4.

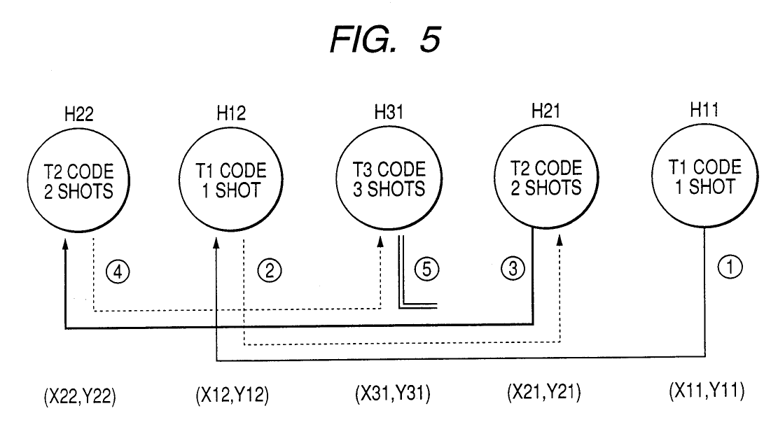

As described above, an example in which procedures of moving the laser beam when a plurality of holes having three types of hole diameters are opened in the substrate 5 by the laser beam having a predetermined diameter is explained. A relationship between the machining position and the machining conditions will be explained with reference to FIG. 5 hereunder. In FIG. 5, the relationship is shown by utilizing a part of the hole arrangement example shown in FIG. 4.

As shown in FIG. 5, suppose that a plurality of holes H11, H21, H31, H12, H22 having different hole diameters are arranged on the substrate 5. Since the machining conditions are set to the holes H11 and H21 belonging to the first group such that the position coordinates on the substrate 5 are (X11, Y11), (X12, Y12) and the hole having a predetermined diameter is opened, the machining conditions in T1 code applied to 1-shot irradiate the laser beam is given.

Also, since the machining conditions are set to the holes H21 and H22 belonging to the second group such that the position coordinates on the substrate 5 are (X21, Y21), (X22, Y22) and the hole having a diameter larger than the predetermined diameter by one stage is opened, the machining conditions in T2 code applied to 2-shot irradiate the laser beam is given. In addition, since the machining conditions are set to the hole H31 belonging to the third group such that the position coordinate on the substrate 5 is (X31, Y31) and the hole having a diameter further larger than the predetermined diameter is opened, the machining conditions in T3 code applied to 3-shot irradiate the laser beam is given.

The procedures of moving the laser beam in the case shown in FIG. 5 are similar to the procedures of moving the laser beam to open a plurality of holes belonging to the first to third groups shown in FIG. 4. The process is started from H11 to which the T1 code is applied and then is moved to H12 in the T1 code in accordance with an arrow of movement 1, and the hole in the T1 code is opened. After all the holes in the T1 code are formed, the process goes to the hole formation in the T2 code in accordance with an arrow of movement 2 indicated by a broken line.

The process is started from H21 to which the T2 code is applied and then is moved to H22 in the T2 code in accordance with an arrow of movement 3, and the hole in the T21 code is opened. After all the holes in the T2 code are formed, the process goes to the hole formation in the T3 code in accordance with an arrow of movement 4 indicated by a broken line. Then, the hole in the T3 code is formed at H31 to which the T3 code is applied. As shown by a double line, after all the holes in the T3 code are formed, the formation of plural holes having three types of different hole diameters on the substrate is finished.

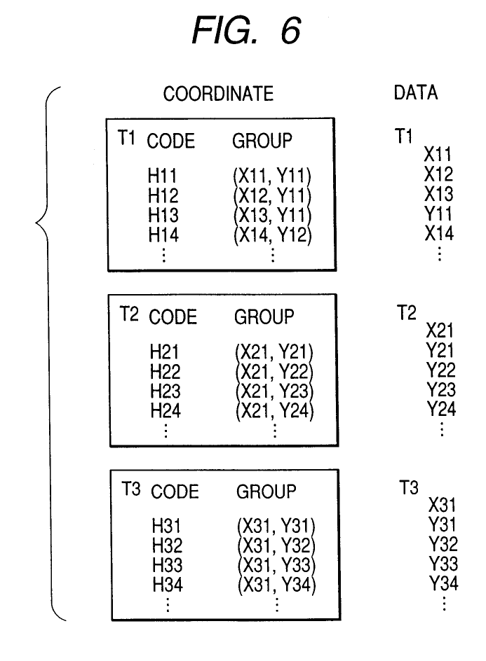

The correlations between the hole groups and the machining positions and the machining conditions, based on the way of correlating the hole machining position with the machining conditions shown in FIG. 5, are shown in FIG. 6. The coordinate values of the hole machining positions are classified into a T1 code group, a T2 code group, and a T3 code group, as surrounded by three square frames, in the coordinate column in FIG. 6.

The coordinate values of the holes set forth in the coordinate column are input by the inputting device (not shown) connected to the control unit 4. In the control unit 4, the machining conditions concerning the hole diameters, i.e., any of the T1 to T3 codes, are given to the input coordinate values by the condition imposing portion 411. Then, the grouping portion 412 classifies all coordinate values into the groups every one of the T1 to T3 codes. Then, the coordinate values that belong to the classified groups are stored in the storing portion 42 as position data.

A configuration of the position data stored here is shown in the data column in FIG. 6. The coordinate values corresponding to respective hole formation positions, to which the T1 to T3 codes are applied selectively as the machining conditions, are stored as the position data column every group. In the example of the position data set forth in this data column, when the X-axis coordinate or the Y-axis coordinate is common in respective groups, one common coordinate out of the X-axis coordinate and the Y-axis coordinate is stored to form the position data column. Thus, a required memory capacity is reduced.

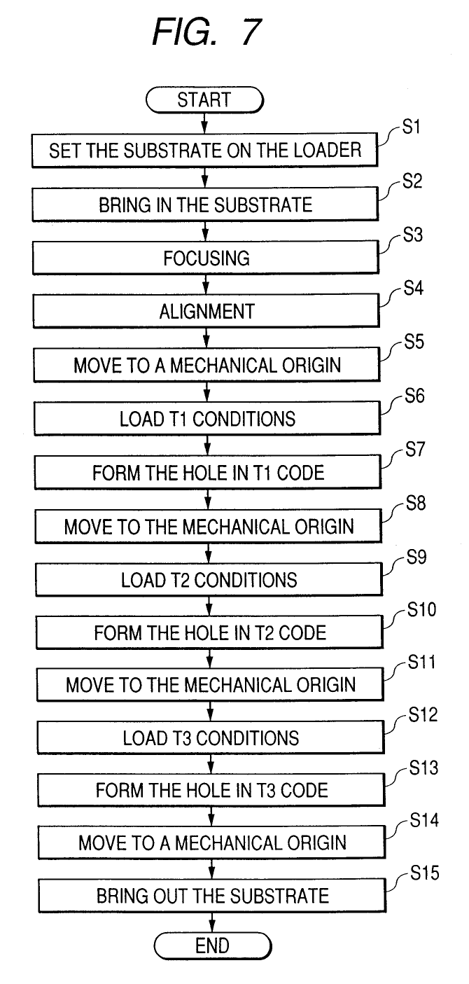

The hole forming procedures taken when a plurality of holes having different hole diameters are formed in the substrate 5, based on the position data column formed in this manner and classified into groups in response to the machining conditions, will be explained with reference to a flowchart in FIG. 7 hereunder.

First, the substrate is set on the loader (step S1), then the substrate is brought into the machining table 3 of the laser machining machine (step S2), and then the substrate is loaded on the machining table. Then, a focusing of the focusing optical system 2 is executed (step S3), and then alignment of the machining table with the substrate is taken (step S4). Then, the machining table is moved/controlled, and a converging point of the laser beam is moved to a mechanical origin (step S5).

Then, the T1 code is selected as the first machining conditions, and the position data column to which the T1 code is applied are loaded (step S6). The control unit 4 controls the motion of the machining table 3 in accordance with the position data column. Then, the formation of the hole having a predetermined diameter is executed by 1-shot irradiating the laser beam every time when the machining table moves to the hole machining position (step S7).

When the hole formation in the position data column to which the T1 code is applied is finished, the machining table is moved/controlled again and the converging point of the laser beam is moved to the mechanical origin (step S8). Then, the T2 code is selected, and the position data column to which the T2 code is applied are loaded (step S9). The machining table is moved/controlled in accordance with the position data column. Thus, the formation of the hole having a diameter larger than the predetermined diameter by one stage is executed by 2-shot irradiating the laser beam every time when the machining table moves to the hole machining position (step S10).

When the hole formation in the position data column to which the T2 code is applied is finished, the machining table is moved/controlled again and the converging point of the laser beam is moved to the mechanical origin (step S11). Then, the T3 code is selected, and the position data column to which the T3 code is applied are loaded (step S12). The machining table 3 is moved/controlled in compliance with the position data column. Thus, the formation of the hole having a diameter larger further is executed by 3-shot irradiating the laser beam every time when the machining table moves to the hole machining position (step S13).

Here, the machining table is moved/controlled again and the converging point of the laser beam is moved to the mechanical origin (step S14). When the holes having the hole diameters different further from the machining conditions in the T1 to T3 codes, a convergence of the laser beam by the focusing optical system is changed, for example, and then the hole formation subsequent to the T4 code can be continued. In the example of the hole formation shown in FIG. 4, since a plurality of holes having three types of hole diameters are opened, all the hole formations are finished at a point of time when the converging point of the laser beam is moved to the mechanical origin in step S14, and then the substrate is brought out from the machining table 3 (step S15).

As described above, the control unit 4 moves/controls the machining table based on the position data columns that are classified into groups in response to the machining conditions in the T1 to T3 codes, and also executes the hole formation in compliance with the program that controls the number of shots of the laser beam. According to this program, the converging point of the laser beam is returned back to the mechanical origin once every time the hole formations grouped into the T1 to T3 codes are ended, then the machining conditions are changed, and then the hole formation in the concerned code group is carried out.

Therefore, according to the above laser machining machine, when a plurality of holes having plural types of hole diameters are opened, a moving operation time to go back to the mechanical origin every time the hole formation of one type is finished is needed in contrast to the case where a plurality of holes having the same diameter are opened on the same surface.

Therefore, in the laser machining method and the laser machining machine according to the second embodiment of the present invention, the configuration of the foregoing laser machining machine is employed as the basis, and then the position data column is formed by converting the position data, which are classified into groups based on the machining conditions, into plural pieces of position data equal to the number of shots of the laser beam under the machining conditions in the machining positions. The control unit of the above laser machining machine controls the position of the machining table while it reads the formed position data column, and irradiates the laser beam with 1-shot every position data. Thus, when the position data showing the same value is repeated plural times, the laser beam is irradiated plural times equal to the number of position data in this machining position that the position data shows.

Such hole forming procedures need merely a change of a part of program that the control unit of the above laser machining machine executes, and facilitates the design in which a plurality of holes having plural types of hole diameters are arranged on the same surface of the substrate. Therefore, when a plurality of holes having plural types of hole diameters are formed, there is no need that the machining table goes back to the mechanical origin every hole with a different hole diameter, and thus such moving time can be saved. In addition, the laser beam output from the laser beam outputting device 1 is always 1-shot irradiated onto one position coordinate, and thus the control of the control unit applied to the laser beam outputting device 1 can be simplified.

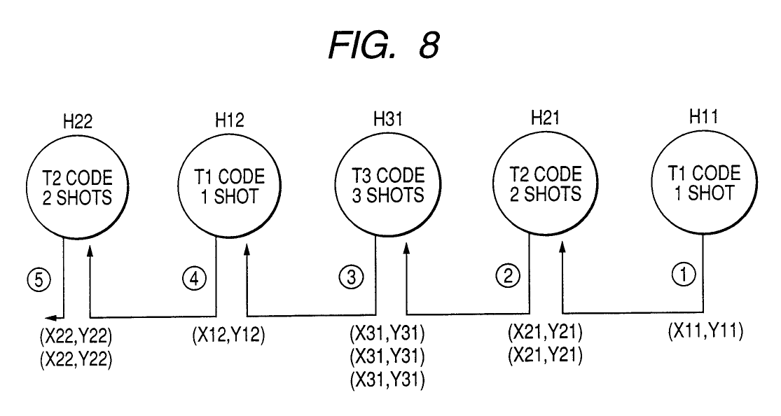

Next, the laser machining method and the machine for the same according to the second embodiment will be explained with reference to FIG. 8 hereunder. Like FIG. 5, FIG. 8 shows an example of the procedures of moving the laser beam when a plurality of holes having three types of hole diameters are opened in the substrate 5 by the laser beam having a predetermined spot. Like FIG. 5, the relationships between the machining positions and the machining conditions in this case are given by utilizing a part of the hole arrangement example shown in FIG. 4.

As shown in FIG. 8, suppose that a plurality of holes H11, H21, H31, H12, H22 having different hole diameters are arranged on the substrate 5. The machining conditions are set to the holes H11 and H21 belonging to the first group such that the position coordinates on the substrate 5 are (X11, Y11), (X12, Y12) and the hole having a predetermined diameter is opened. Therefore, the machining conditions in the T1 code applied to 1-shot irradiate the laser beam is needed.

Also, since the machining conditions are set to the holes H21 and H22 belonging to the second group such that the position coordinates on the substrate 5 are (X21, Y21), (X22, Y22) and the hole having a diameter larger than the predetermined diameter by one stage is opened, the machining conditions in the T2 code applied to 2-shot irradiate the laser beam is needed. In addition, since the machining conditions are set to the hole H31 belonging to the third group such that the position coordinate on the substrate 5 is (X31, Y31) and the hole having a diameter further larger than the predetermined diameter is opened, the machining conditions in the T3 code applied to 3-shot irradiate the laser beam is needed.

The procedures of moving the laser beam in the case shown in FIG. 8 are different from the procedures of moving the laser beam to open a plurality of holes belonging to the first to third groups shown in FIG. 5. When the position data column is to be formed, each position coordinate is assigned to H11 and H12, to which the T1 code is applied, one by one respectively, each position coordinate is assigned to H21 and H22, to which the T2 code is applied, two by two respectively, and the position coordinate is assigned to H31, to which the T3 code is applied, three by three. Thus, the position data column is formed.

For example, in the case of the hole H21, the hole formation position coordinates (X21, Y21) are assigned twice to the hole H21 since the T2 code is applied. If it is programmed that the laser beam is 1-shot irradiated every position data when the control unit 4 reads the position data column, consequently the laser beam is 2-shot irradiated to the same hole forming position. Thus, the hole having the hole diameter larger than the predetermined diameter of the 1-shot laser beam by one stage can be opened.

In this manner, since the position data of the machining position are assigned plural time in response to plural types of hole diameters, it is not required that the machining conditions should be called every group, and the laser beam is always 1-shot irradiated in accordance with the position data in the position data column. Therefore, even though the holes having three types of hole diameters are opened as shown in FIG. 8, the movements 2, 4 indicated by a broken line shown in FIG. 5 and executed every time when the hole formation in one group is finished can be omitted, i.e., there is no need to go back to the mechanical origin each time, so that a moving distance can be shortened.

Even when the holes having different hole diameters are present alternately as shown in FIG. 8, the laser beam is moved sequentially from the end as indicated by arrows of the movement 1 to the movement 5. Then, H11 is irradiated with 1 shot of the laser beam, H21 is irradiated with 2 shots, H31 is irradiated with 3 shots, H12 is irradiated with 1 shot of the laser beam, and H22 is irradiated with 2 shots. In this manner, the holes having plural type of hole diameters, which are positioned alternately, can be opened by a series of movements of the laser beam.

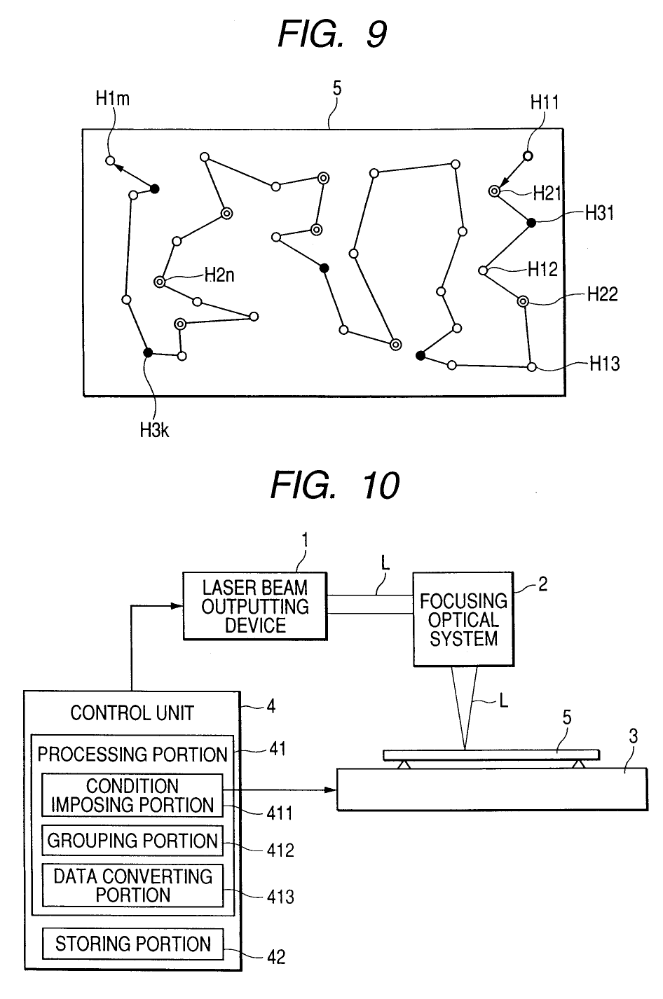

Therefore, an example in which the laser machining method of the second embodiment is shown in FIG. 9 with reference to the example of the case where a plurality of holes having three type of hole diameters are opened in the substrate 5, as shown in FIG. 4. In FIG. 9, like FIG. 4, the white dot indicates the machining position of the hole having a smallest diameter, the double circle indicates the machining position of the hole having a diameter larger than the smallest diameter by one stage, and the black dot indicates the machining position of the hole having a diameter further larger by one stage.

As shown in FIG. 8, according to the laser machining method of the second embodiment, even though the holes having different hole diameters are present alternately on the same surface of the substrate, the number of shots of the laser beam are changed upon irradiating the laser beam in response to the different diameters. Therefore, the holes having plural types of hole diameters, which are present alternately, can be opened easily and, if a route as a shortest distance between the hole positions is calculated, the hole formation can be carried out effectively through a minimum movement of the laser beam by the way of one stroke of the pen. In the example in FIG. 9, H11 acts as the starting point in opening the hole on the same surface of the substrate 5 and also H1m acts as the ending point of all the hole formations.

A schematic configuration of the laser machining machine to which the laser machining method of the second embodiment is applied is shown in FIG. 10. The laser machining machine shown in FIG. 10 employs the laser machining machine shown in FIG. 1 as the basis, and the same reference symbols are affixed to the same portions. A difference of the laser machining machine shown in FIG. 10 from the laser machining machine shown in FIG. 1 is that a data converting portion 413 is provided to the processing portion 41.

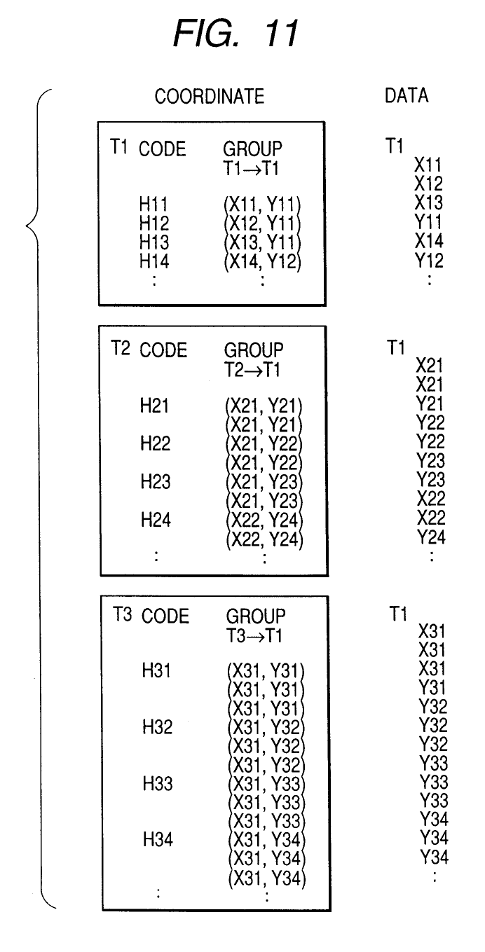

Next, an operation of the processing portion 41 in the laser machining machine shown in FIG. 10 will be explained with reference to data configuration shown in FIG. 11 hereunder. In FIG. 11, like the case shown in FIG. 6, the case where the machining positions of a plurality of holes having three types of hole diameters are given is shown by way of example.

Like the position coordinates set forth in the coordinate column in FIG. 6, the position coordinates of respective holes are input by the inputting device (not shown) connected to the control unit 4. Therefore, the machining conditions concerning the hole diameters, i.e., any of the T1 to T3 codes, are given to the input position coordinates by the condition imposing portion 411. Then, the grouping portion 412 classifies all position coordinates into the groups every one of the T1 to T3 codes.

In addition, the data converting portion 413 still keeps the T1 code of the position coordinate, to which the T1 code is applied, out of the position coordinates that belong to the classified groups, and then assigns one position coordinate to the holes H11, H12, H13, . . . respectively. Also, the data converting portion 413 replaces the T2 code of the holes H21, H22, H23, . . . belonging to the T2 code group with the T1 code, and then assigns two position coordinates to the holes H21, H22, H23, . . . respectively. Then, the data converting portion 413 replaces the T3 code of the holes H31, H32, H33, . . . belonging to the T3 code group with the T1 code, and then assigns three position coordinates to the holes H31, H32, H33, . . . respectively. This situation is schematically shown in the coordinate column of FIG. 11.

Then, the data converted by the data converting portion 413 are stored in the storing portion 42 as the position data regarding the formation of the holes that are converted into the T1 code. A configuration of the position data stored here is shown in the coordinate column of FIG. 11. The coordinate values corresponding to the forming positions of respective holes are stored as the position data column that are converted into the T1 code every one of the T1 to T3 codes.

In the example of the position data set forth in this data column, like the case shown in FIG. 6, when the X-axis coordinate or the Y-axis coordinate is common in respective groups, one common coordinate out of the X-axis coordinate and the Y-axis coordinate is stored to form the position data column. Therefore, when the X-axis coordinate or the Y-axis coordinate is common, one position data corresponding to the X-axis coordinate or the Y-axis coordinate is stored, and the position data corresponding to the same X-axis coordinate or the same Y-axis coordinate are aligned in plural in the position data column in the T2 and T3 code groups.

For example, in the case of the hole H21 shown in FIG. 11, since the hole H21 corresponds to the machining conditions in the T2 code, the position data of the hole H21 contain two X22 on the X-axis coordinate and two Y22 on the Y-axis coordinate. However, since the common position data are excluded in forming the position data column when the coordinate positions is not changed, one Y22 is removed, and thus the position data column regarding the hole H21 consists of X21, X21, Y21. Also, in the case of the hole H22, since the X-axis coordinate is X21 and is equal to the X-axis coordinate of the hole H21, X21 is removed from the position data column regarding the hole H22, and thus the position data column consists of Y22, Y22.

Further, when the route acting as the shortest distance is calculated between the hole forming positions and then the hole formation is executed by the way of one stroke of the pen such that the moving route of the laser beam is reduced to the lowest minimum, the position data columns formed like the data column in FIG. 11 are realigned in order of shorter route. Since all the T1 to T3 codes as the machining conditions are converted into the T1 code, this realignment can be achieved even in the formation of plural holes having plural types of hole diameters.

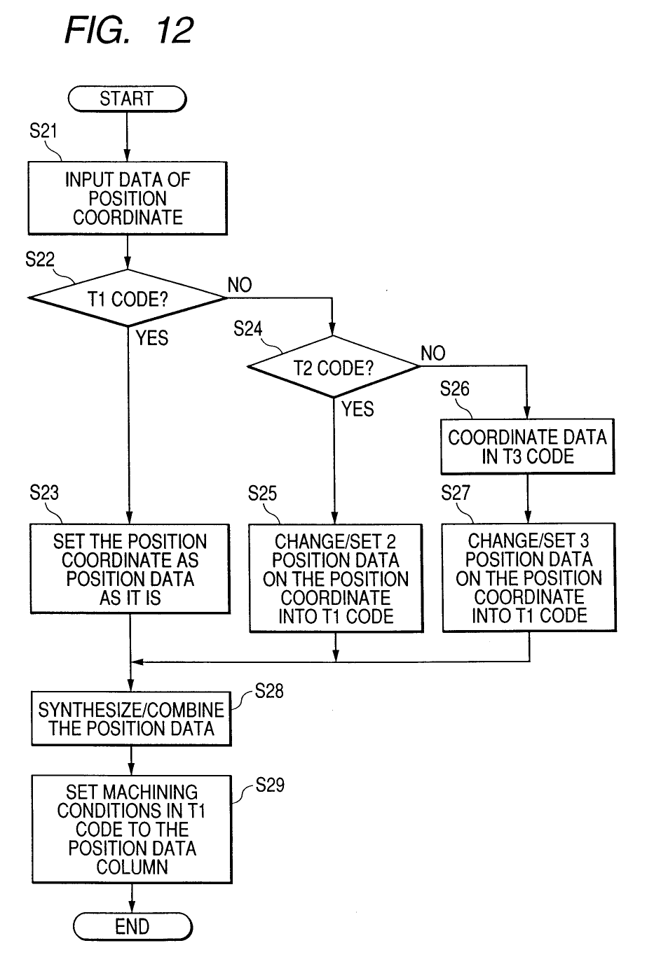

Now, an example of procedures of forming the position data column explained as above will be explained with reference to a flowchart in FIG. 12 hereunder.

First, the data of the position coordinate of the holes that must be opened on the same surface of the substrate are input by the inputting device connected to the control unit (step S21). Then, it is decided whether or not the input position coordinate corresponds to the machining conditions in the T1 code (one shot) (step S22). If the position coordinate belongs to the T1 code (Y in step S22), the position data on the position coordinate is set as it is (step S23).

In contrast, if the position coordinate does not belong to the T1 code (N in step S22), there is a possibility that such position coordinate belongs to the T2 or T3 code. Therefore, it is decided whether or not the hole machining conditions on that position coordinate belongs to the T2 code (step S24). If the position coordinate belongs to the T2 code (Y in step S24), the position data on the position coordinate is set by two pieces of data and the T2 code is changed/set into the T1 code (step S25).

Also, if the position coordinate does not belong to the T2 code (N in step S24), such position coordinate corresponds to the coordinate data in the T3 code (step S26). Then, the position data on the position coordinate is set by three pieces of data and also the T3 code is changed into the T1 code (step S27).

In the above steps S23, S25, and S27, all the position coordinates input to form the hole are classified into groups in response to the machining conditions and the position coordinates belonging to respective groups are set as the position data column, which is converted to correspond to the T1 code, in all cases of the T1 to T3 codes. Therefore, these position data are combined with each other (step S28), and the position data column into which the machining conditions in the T1 code are set is formed (step S29).

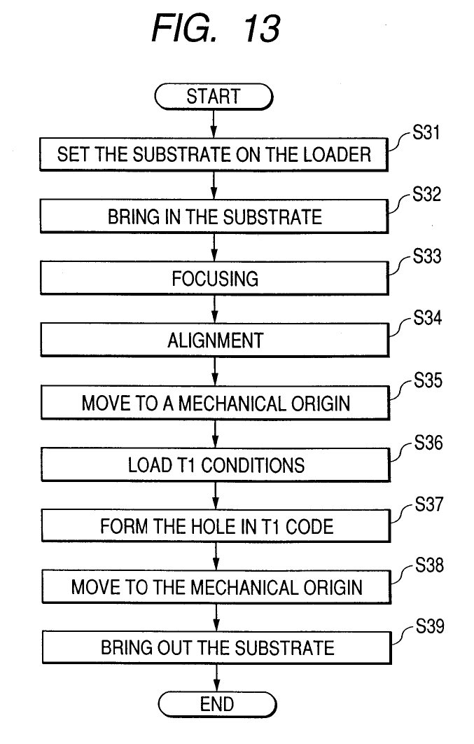

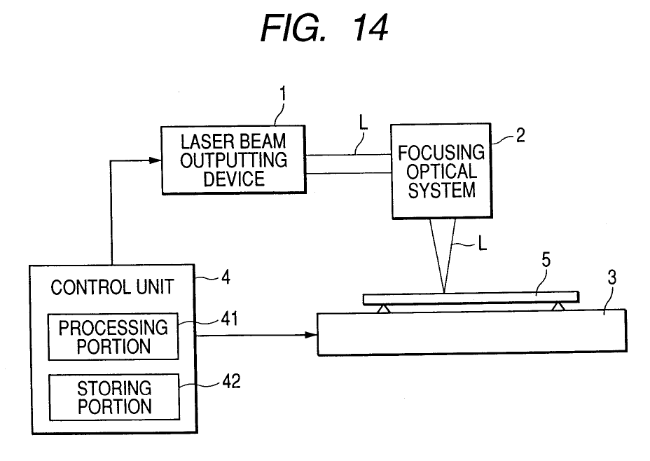

Then, based on the position data column which is formed in this manner and in which all position coordinates are converted into the T1 code, procedures of forming a plurality of holes having different diameters in the substrate 5 will be explained with reference to a flowchart in FIG. 13 hereunder. Here, suppose that the laser machining machine shown in FIG. 10 is employed.

First, the substrate is set on the loader (step S31), then the substrate is brought into the machining table 3 of the laser machining machine (step S32), and then the substrate is loaded on the machining table. Then, a focusing of the focusing optical system 2 is executed (step S33), and then alignment of the machining table with the substrate is taken (step S34). Then, the machining table is moved/controlled, and the converging point of the laser beam is moved to the mechanical origin (step S5).

Then, the T1 code is selected as the machining conditions and then the position data column to which the T1 code is applied is loaded (step S36). The control unit 4 controls the movement of the machining table 3 in compliance with this position data column. Then, the formation of the hole having a predetermined diameter is executed by 1-shot irradiating the laser beam every time when the machining table 3 is moved to the hole forming position (step S37). At this time, when the same position data of such machining position is called successively, the laser beam is 1-shot irradiated again and thus the formation of the hole having the hole diameter larger than the predetermined diameter by one stage is executed. Also, when the same position data is continued further, the laser beam is 1-shot irradiated once again and thus the hole having the further larger hole diameter is opened.

In this manner, the 1-shot irradiation of the laser beam is executed in the machining position, which is indicated by all the position data in the called position data column, plural times equal to the number of the position data. Thus, a plurality of holes having plural types of hole diameters are opened wholly on the same surface of the substrate. Then, a converging point of the laser beam is moved to the mechanical origin, and the machining table is prepared for the subsequent hole opening process applied to the substrate (step S38). Then, the substrate is unloaded/bring out from the machining table (step S39). Thus, the hole opening process on the substrate is ended.

As explained above, according to the laser machining method of the first and second embodiments of the present invention, even though the holes having different hole diameters are alternately on the same surface of the substrate, if a converging diameter of the 1-shot laser beam is set to the same size as a minimum diameter of plural types of hole diameters, for example, if such converging diameter is set to a predetermined diameter 50 μm in the case shown in the graph in FIG. 2, the hole having a diameter larger than the predetermined diameter by about 50 μm can be opened with 2 shots and the hole having a diameter larger than the predetermined diameter by about 10 μm can opened with 3 shots.

Further, according to the laser machining method of the second embodiments of the present invention, in order to form a plurality of holes having different hole diameters on the same surface, merely a change of the number of shots of the laser beam is needed upon irradiating the laser beam when the machining table is moved to the machining position. Therefore, a plurality of holes having different hole diameters, which are present alternately, can be opened easily. When the route serving as a shortest distance between the hole opening positions is calculated, the hole formation can executed effectively by the minimum movement of the laser beam with one stroke of the pen, and also a hole machining time can be reduced.

According to the laser machining method of the first and second embodiments of the present invention, in this manner, even though the holes having different hole diameters exist alternately on the same surface of the substrate, if a converging diameter of the 1-shot laser beam is set to agree with the minimum diameter of plural types of hole diameters, the hole having the diameter larger than the minimum diameter can be opened with plural shots of the laser beam. As a result, a plurality of vias of plural types of hole diameters can be arranged at need in the same layer of the multi-layered wiring substrate, or the like, and thus a margin of design of the wiring substrate can improved.

Here, advantages of the laser machining method of the present embodiment attained when 100000 vias, for example, are opened in one layer of the multi-layered wiring substrate will be explained hereunder. Suppose that, out of theses 100000 vias, a diameter of 1000 vias should be enlarged larger than the predetermined diameter by 5 μm respectively.

In the case of the above laser machining method according to the first embodiment of the present invention, first the 99000 vias having the predetermined diameter are opened from the side located closer to the mechanical origin. Then, the 1000 vias having a diameter larger than predetermined diameter are opened from the side located closer to the mechanical origin. In this case, a machining time required for the 99000 vias having the predetermined diameter was about 117 second, and a machining time required for the 1000 vias having the large diameter was about 30 second. It took about 150 second to form the 100000 vias having two types of hole diameters including a return time to the mechanical origin.

Inn the case of the laser machining method according to the second embodiment of the present invention, when the 100000 vias are opened in the same layer, the formation of the holes having two types of hole diameters can be carried out from the side located closer to the mechanical origin by switching the number of shots of the laser beam. Therefore, even when the 1000 vias having the diameter larger than the predetermined diameter by 5 μm are to be formed, a time required to form the 100000 vias was about 119 second and the formation of all holes can be completed. In this manner, according to the laser machining method of the present embodiment, even though the holes having different hole diameters are mixed together, the hole formation can be carried out at a speed in the same extent as that used to form the vias having the same hole diameter wholly.

In the case where the laser machining method according to the present embodiment is applied to the via formation in the multi-layered wiring substrate, when a layout of a plurality of vias having plural types of hole diameters are designed in one layer of the multi-layered wiring substrate, a hole machining time can be reduced much more by designing the vias having the minimum via diameter out of plural types of via diameters as much as possible.

Also, in the laser machining method according to the present embodiment explained as above, when the formation of a plurality of holes having different hole diameters is applied to the work piece, the irradiating portion of the laser machining machine to irradiate the laser beam onto the work piece is fixed in a fixed place, while the machining table on which the work piece is loaded is moved/controlled in compliance with the position data. Conversely, the machining table on which the work piece is loaded can be fixed in a fixed place, and then a plurality of holes having different hole diameters can be opened sequentially in the work piece while moving/controlling the irradiating portion of the laser machining machine in compliance with the position data.

What is claimed is:

1. A laser machining method of opening a plurality of holes having different hole diameters in a work piece by irradiating a laser beam converged into a predetermined diameter, comprising:
a moving step of relatively moving an irradiating unit of the laser beam, the predetermined diameter of which is converged to agree with a minimum diameter among the plurality of holes, to a machining position of the hole sequentially; and
an irradiating step of irradiating the laser beam predetermined times in response to a size of the hole diameter at the machining position when the irradiating unit is relatively moved to the machining position respectively.

2. A laser machining method according to claim 1, wherein, after the irradiating unit is relatively moved to the machining position, the laser beam is irradiated once to the work piece when the hole diameter in the machining position is the minimum diameter, and the laser beam is irradiated twice or more to the work piece in response to a size of the hole diameter when the hole diameter in the machining position is larger than the minimum diameter.

3. A laser machining method according to claim 1, wherein the irradiating unit is moved via a route selected such that a moving distance between machining positions of the plurality of holes is shortest.

4. A laser machining method according to claim 1, further comprising;
an inputting step of inputting machining position data and hole diameter information of the plurality of holes;
a grouping step of grouping the machining position data in response to sizes of the hole diameters contained in the hole diameter information about the plurality of holes; and
a condition imposing step of imposing a condition to irradiate the laser beam once to the machining position data belonging to a group in which the hole diameter is a smallest diameter, and imposing a condition to irradiate the laser beam twice or more sequentially in response to a size of the hole diameter to the machining position data belonging to respective groups in which the hole diameters are classified in order of larger diameter than the minimum diameter;
wherein the laser beam is irradiated predetermined times in compliance with the condition imposed to the machining position data when the irradiating unit is moved to respective machining positions.

5. A laser machining method according to claim 4, wherein the machining position data has position coordinates on the work piece, and
the laser machining method further comprises: a data converting step of converting the machining position data by setting one position coordinate on the machining position under a condition the laser beam is irradiated once, and setting two position coordinates or more on the machining position under a condition the laser beam is irradiated twice or more in response to the size of the hole diameter, wherein
the laser beam is irradiated predetermined times equal to the number of position coordinates in compliance with the number of position coordinates contained in the machining position data when the irradiating unit is moved to respective machining positions.

6. A laser machining method according to claim 1, wherein, after the irradiating unit is moved to the machining position, when the hole in the machining position is a power supply wiring via, a stacked via to which a stress like a thermal stress is applied, or a via that undergoes a through hole plating, the laser beam is irradiated twice or more in response to a size of the hole diameter.

7. A laser machining machine, comprising:
an irradiating unit for converging a laser beam into a predetermined diameter to agree with a minimum diameter among a plurality of holes that are opened in a work piece and have different hole diameters, and irradiating the laser beam onto the work piece from an irradiating portion;
a moving unit for relatively moving machining positions of the plurality of holes in the work piece sequentially to a converged position of the laser beam; and
a controlling unit for controlling a laser beam irradiation by the irradiating unit and alignment of the machining position with the converged position;
wherein the control unit causes the irradiating unit to irradiate the laser beam predetermined times in response to a size of the hole diameter in the machining position when the irradiating unit is relatively moved to the machining positions of the plurality of holes sequentially.

8. A laser machining machine according to claim 7, wherein, after the irradiating unit is relatively moved to the machining position, the control unit causes the irradiating unit to irradiate the laser beam once to the work piece when the hole diameter in the machining position is the minimum diameter, and causes the irradiating unit to irradiate the laser beam twice or more to the work piece in response to a size of the hole diameter when the hole diameter in the machining position is larger than the minimum diameter.

9. A laser machining machine according to claim 7, wherein the control unit causes the irradiating unit to move via a route selected such that a moving distance between machining positions of the plurality of holes is shortest.

10. A laser machining machine according to claim 7, further comprising;
an inputting unit for inputting machining position data and hole diameter information of the plurality of holes; and
a storing unit for storing the input machining position data and the input hole diameter information of the plurality of holes;
wherein the control unit includes
a grouping section for reading the machining position data and the hole diameter information from the storing unit, and then grouping the machining position data in response to sizes of the hole diameters contained in the hole diameter information about the plurality of holes,
a condition imposing section for imposing a condition to irradiate the laser beam once to the machining position data belonging to a group in which the hole diameter is a smallest diameter, and imposing a condition to irradiate the laser beam twice or more sequentially in response to a size of the hole diameter to the machining position data belonging to respective groups in which the hole diameters are classified in order of larger diameter than the minimum diameter, and
the control unit causes the irradiating unit to irradiate the laser beam predetermined times in compliance with the condition imposed to the machining position data when the irradiating unit is moved to respective machining positions.

11. A laser machining machine according to claim 10, wherein the machining position data input into the inputting unit has position coordinates on the work piece,
the control unit has a data converting section for setting one position coordinate on the machining position in respective machining position data under a condition the laser beam is irradiated once, and setting two position coordinates or more on the machining position in respective machining position data under a condition the laser beam is irradiated twice or more in response to the size of the hole diameter, and
the control unit causes the irradiating unit to irradiate the laser beam predetermined times equal to the number of position coordinates in compliance with the number of position coordinates converted by the data converting section when the irradiating unit is moved to respective machining positions.

12. A laser machining machine according to claim 11, wherein the data converting section forms coordinate data columns that contain X-axis coordinate data and Y-axis coordinate data of plural pieces of machining position data, and formed the coordinate data column to contain only one piece of the X-axis coordinate data and Y-axis coordinate data when the X-axis coordinate data or Y-axis coordinate data of the machining position data is same in groups on which a condition that the laser is irradiated twice or more in response to a size of the hole diameter is imposed.

13. A laser machining machine according to claim 7, wherein, after the irradiating unit is moved to the machining position, when the hole in the machining position is a power supply wiring via, a stacked via to which a stress like a thermal stress is applied, or a via that undergoes a through hole plating, the irradiating unit irradiates the laser beam twice or more in response to a size of the hole diameter.
